(19) United States
(12) Patent Application Publication
(10) Pub. No.: US 2019/0050439 A1
(43) Pub. Date: Feb. 14, 2019

(54) SYSTEM AND METHOD FOR SECURE CROWDSOURCED DATA UPDATES

(71) Applicant: Thomas James Fast, Norwalk, CT (US)

(72) Inventor: Thomas James Fast, Norwalk, CT (US)

(21) Appl. No.: 16/100,143

(22) Filed: Aug. 9, 2018

Related U.S. Application Data
(60) Provisional application No. 62/543,273, filed on Aug. 9, 2017.

(51) Int. Cl. G06F 17/30; H04L 12/58; H04L 29/08; G06Q 50/00

(52) U.S. Cl. CPC G06F 17/30345; H04L 51/32; H04L 67/26; G06Q 50/01; H04L 67/306

(57) ABSTRACT

The present disclosure relates to methods and systems for providing secure crowdsourced updates of large datasets. More specifically embodiments of the present invention are directed to providing a secure outreach system that individuals, companies, government bodies or other organizations can use to gather information on various contacts and other data points.

### CROSS-REFERENCE TO RELATED APPLICATIONS

This application claims priority to U.S. provisional application 62/543,262 filed Aug. 9, 2017, the contents of which, and all other referenced extrinsic materials, are incorporated herein by reference in their entirety. This application also claims priority to U.S. provisional application 62/543,273 filed Aug. 9, 2017, the contents of which, and all other referenced extrinsic materials, are incorporated herein by reference in their entirety. Where a definition or use of a term in a reference that is incorporated by reference is inconsistent or contrary to the definition of that term provided herein, the definition of that term provided herein is deemed to be controlling.

### FIELD OF INVENTION

The present disclosure relates to methods and systems for providing secure crowdsourced updates of large datasets. More specifically embodiments of the present invention are directed to providing a secure outreach system that individuals, companies, government bodies or other organizations can use to gather information on various contacts and other data points.

### BACKGROUND

For many people, the days of one city, one job, one address, one phone number, and one email address is over. Global business and corporate relocations have fueled this trend and these trends, in all likelihood, will only continue to accelerate with the emergence of the “gig” economy. Most people will only update their information with critical companies and contacts. This is making contact information increasingly dynamic and making stagnant CRM databases rapidly outdated.

Further, with new regulations pushing requirements on organizations and companies that contact information must be kept up to date, or otherwise removed, there are new impetus for these organizations and companies to ensure that their contact, and other information that could be considered personally identifiable information (PII), are maintained in accordance with these new standards.

Information is also moving at increasing speeds over the internet, through social media, and on round-the-clock news. That has the potential to shift people's attitudes, opinions, and actions quickly. This necessitates more frequent surveying of opinions and trends. Fortunately, the proliferation of smartphones, tablet PCs and other portable computing devices have made it possible to reach most people quickly and cheaply.

However, even with these modern devices making communication more accessible, there still lacks the systems and methods companies and organizations need in order to ensure the freshness of their contact and other PII. Given the sensitivity of contact and PII data, there is also a need to ensure the security of such information, and place restrictions on its use, where applicable.

Therefore, there is still a need in the art for systems and methods for providing secure data updates and restrictions on use of such data updates.

### SUMMARY OF INVENTION

Accordingly, the subject matter described herein provides systems, methods, and computer-readable non-transitory storage mediums for secure outreach that individuals, companies, governments or organizations can use to gather information from many contacts.

According to an embodiment of the present invention, a computerized method for securely gathering information from a plurality of contacts comprises the steps of: receiving a first contact data set comprising one or more contact information entries; generating a contact message for each of said one or more contact information entries, wherein each contact message comprises a unique response identifier associated with one of said one or more contacts information entries; receiving a response message, wherein said response message is received in conjunction with usage of the unique response identifier; generating a verification interface based on a contacts information entry associated with said unique response identifier, wherein said verification interface comprises one or more verification challenge response tests; providing said verification interface to a computing device identified in said response message; receiving verification information, directly or indirectly, from said computing device identified in said response message; validating verification information; receiving information, directly or indirectly, from said computing device identified in said response message; and synchronizing information for said contacts information entry associated with said unique response identifier.

According to an embodiment of the present invention, the method further comprises the step of transmitting said contact message through a communication channel to a computing device associated with said one or more contact information entries.

According to an embodiment of the present invention, said communication channel is selected from one or more of the group comprising: push notifications, SMS messages, email, social media platforms, mail, VOIP, voice calls, chat platforms, and advertisements.

According to an embodiment of the present invention, the method further comprises the steps of receiving campaign information comprising selection of contact entries for use in said first contact data set; generating a campaign based on said campaign information, wherein said campaign comprises one or more of content for said contact message, time to live information for said unique response identifier, and triggers for sending additional contact messages.

According to an embodiment of the present invention, the method further comprises the steps of analyzing said one or more information entries of said first data set for entries that are restricted and removing restricted entries from said one or more information entries from said first data set.

According to an embodiment of the present invention, the method further comprises the steps of identifying a means of connection with said computing device identified in said response message and selecting a type of verification interface to be generated based on said means of connection with said computing device identified in said response message.

According to an embodiment of the present invention, said type of verification interface may be selected from the group comprising: user interfaces, messaging systems, call systems, encrypted response forms, unencrypted response forms, voice engines and chat engines.

According to an embodiment of the present invention, the method further comprises the steps of comparing said information to information previously contained in said information entry associated with said unique response identifier and flagging said information for review based on one or more rules or automatically correcting said information.

According to an embodiment of the present invention, the method further comprises the step of disregarding said information wherein said information violates one or more of said one or more rules.

According to an embodiment of the present invention, the method further comprises the step of saving version information for each information record for said information entry associated with said unique response identifier in order to allow for later rollback of information.

According to an embodiment of the present invention, a computerized system for securely gathering information from a plurality of contacts comprises: a multi-channel outreach module, comprising computer-executable code stored in non-volatile memory; a processor; and one or more computer messaging devices; wherein the multi-channel outreach module, the processor, and the one or more computer messaging devices are configured to: receive a first contact data set comprising one or more contact information entries; generate a contact message for each of said one or more contact information entries, wherein each contact message comprises a unique response identifier associated with one of said one or more contact information entries; receive a response message, wherein said response message is received in conjunction with usage of the unique response identifier; generate a verification interface based on a contact information entry associated with said unique response identifier, wherein said verification interface comprises one or more verification challenge response tests; provide said verification interface to a computing device identified in said response message; receive verification information, directly or indirectly, from said computing device identified in said response message; validate verification information; receive contact information, directly or indirectly, from said computing device identified in said response message; and synchronize information for said contacts information entry associated with said unique response identifier.

According to an embodiment of the present invention, the multi-channel outreach module, the processor, and the one or more computer messaging devices are further configured to: transmit said contact message through a communication channel to a computing device associated with said one of said one or more contact information entries.

According to an embodiment of the present invention, the multi-channel outreach module, the processor, and the one or more computer messaging devices are further configured to: receive campaign information comprising selection of contact entries for use in said first contact data set; and generate a campaign based on said campaign information, wherein said campaign comprises one or more of content for said contact message, time to live information for said unique response identifier, and triggers for sending additional contact messages.

According to an embodiment of the present invention, the multi-channel outreach module, the processor, and the one or more computer messaging devices are further configured to: analyze said one or more contact information entries of said first data set for entries that are restricted; and remove restricted entries from said one or more contact information entries from said first data set.

According to an embodiment of the present invention, the multi-channel outreach module, the processor, and the one or more computer messaging devices are further configured to: identify a means of connection with said computing device identified in said response message; and select a type of verification interface to be generated based on said means of connection with said computing device identified in said response message.

According to an embodiment of the present invention, the multi-channel outreach module, the processor, and the one or more computer messaging devices are further configured to: compare said information to information previously contained in said contacts information entry associated with said unique response identifier; and flag said information for review based on one or more rules or automatically correcting said information.

According to an embodiment of the present invention, the multi-channel outreach module, the processor, and the one or more computer messaging devices are further configured to disregard said information wherein said information violates one or more of said one or more rules.

According to an embodiment of the present invention, the multi-channel outreach module, the processor, and the one or more computer messaging devices are further configured to save version information for each contacts information for said contacts information entry associated with said unique response identifier in order to allow for later rollback of information.

Various objects, features, aspects and advantages of the disclosed subject matter will become more apparent from the following detailed description of embodiments, along with the accompanying drawing figures in which like numerals represent like components.

### BRIEF DESCRIPTION OF THE DRAWINGS

FIG. 1 is an illustration of an outreach system, in accordance with an embodiment of the present invention.

FIG. 2 is an illustration of a response system, in accordance with an embodiment of the present invention.

FIG. 3 is an illustration of an interactive response system, in accordance with an embodiment of the present invention.

FIG. 4 is an illustration of a result view system in accordance with an embodiment of the present invention.

FIG. 5 is an exemplary embodiment of a method for providing secure crowdsourced updates of large datasets.

FIG. 6 is an exemplary embodiment of a method for providing secure crowdsourced updates of large datasets.

### DETAILED DESCRIPTION

The present disclosure relates to methods and systems for providing secure crowdsourced updates of large datasets. More specifically embodiments of the present invention are directed to providing a secure outreach system that individuals, companies, government bodies or other organizations can use to gather information on various contacts and other data points.

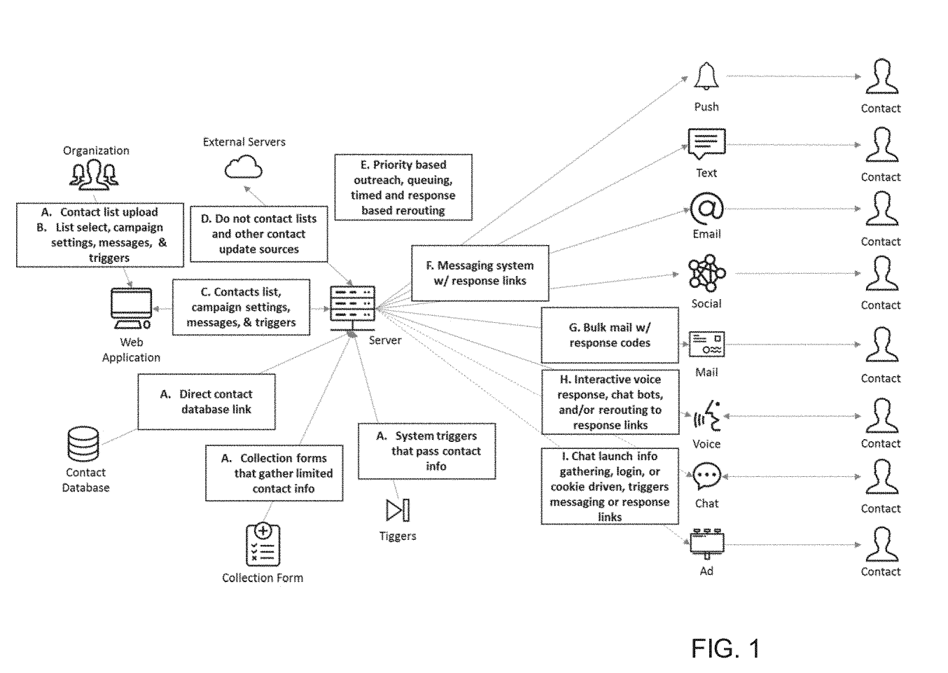

Turning first to FIG. 1, an illustration of an outreach system, in accordance with an embodiment of the present invention. In a preferred embodiment, the outreach system is configured to provide connection means with one or more contacts in order to gather information.

As shown in FIG. 1., the system is configured to provide the ability to add contact information. For instance, the system may provide means for uploading of a contact list, synchronization of a contact list from a database connection, feeding contact data from a system form, passing information to a system based on set triggers, or any combination thereof. One of ordinary skill in the art would appreciate that there are numerous methods in which the system could provide the ability to add contact information to its data stores. Further embodiments may include a system configured to provide filtering and automated cleaning and formatting of input data. For the purposes of this application, contact information may include, but is not limited to, information associated with contacting an individual (e.g., phone number, email address, physical address), but also may include other information or data associated with the individual, such as age, birthdate, gender or other personally identifiable information, and further may include information such as survey results (e.g., general secured survey results—for example a media viewership survey or political survey where they want certain individuals to access, but not the general public—the system may generate a unique link to the intendent targets with or without a pin code to prevent a bot from influencing results). Herein, the term information and contact information may be used interchangeably.

According to an embodiment of the present invention, the system is further configured to allow for the creation of campaigns. In a preferred embodiment, the system may comprise an outreach module that is configured to provide functionality for the creation of unique outreach campaigns. Creation of a campaign may include, but is not limited to, selecting from available contact lists, creating campaign messages, adjusting campaign settings (such as time links are alive, routing of messages, number of reattempts), and setting of triggers for sending new messages (such as confirm every new customer's information or attempt an update when a number of messages go un-opened).

The system may be further configured to allow for the passing of campaign information from an administration module to a server for execution. One of ordinary skill in the art would appreciate that the passing of information from an administration module on to execution need not be done via a client/server form, but rather could be implemented in a variety of ways, including via distributed systems or virtual hosts or entirely via a single computing device. Each manner of implementing the system is contemplated for use with the embodiments herein.

According to a preferred embodiment of the present invention, the system is further configured to allow for identifying contacts associated with one or more restrictions on contact limitations. For instance, the system may be configured to verify whether or not individuals and their specified contact means are listed on a do-not-call list for legal compliance and against other recent updates to confirm a contact is not being overwhelmed with requests.

The system may still be further configured to allow for campaign outreach management. In such embodiments, the system provides message queuing and processing following campaign setup and implementation, whereby the system utilizes settings for time outs, reattempts, and rerouting of messages intended to be delivered.

According to an embodiment of the present invention, the system is further configured to allow sending messages through a propriety system or external communication means, such as one or more application programming interfaces (APIs). In these embodiments, messages may be generated with a unique identifier (e.g., unique URL, GUID) that identifies the respondent for verification and/or pre-population of information.

Preferred embodiments of the system also are configured to send messages or print items with unique response codes for channels without clickable links. For instance, letters, post cards or other mailings may be printed with barcodes, unique passcodes, QR code or other form of unique identifier. One of ordinary skill in the art would appreciate that there are numerous types of unique identifiers that could be utilized with embodiments of the present invention, and embodiments of the present invention are contemplated for use with any appropriate unique identifiers.

The system may be further configured to utilize interactive response means in order to communicate with respondents. For instance, the system may utilize one or more of pre-recorded calls, chat bots, call bots, touch tone response systems, or any combination thereof. By utilizing such means, the system is able to “verbally” verify and gather information, or collect data (e.g., getting a mobile number for a respondent) for sending a response link or other further communication with the respondent.

In one embodiment, the system may be configured to utilize site ads, pop ups, or support functions in order to communicate with contacts. In these embodiments, the system may be configured to route users to update forms using known information about a logged in user or provided on the site. For instance, by using cookies or other metadata available to the system, the system may identify the user of a computing device as a candidate for contact by the system, and submit an advertisement to the user based on this identification. In general, the system may be configured to interact with third-party advertisement platforms (e.g., Facebook Ads, Google AdWords) to effect the display of advertisements with unique URL to the user.

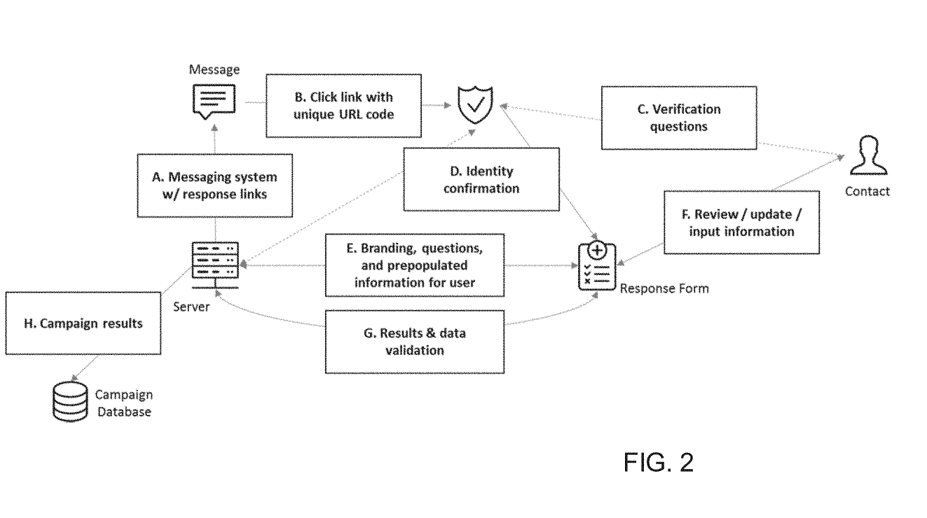

Turning now to FIG. 2, a method for data collection via response forms that may be utilized in preferred embodiments of the present invention is shown. In this embodiment, the collection process starts by the user interacting with the unique identifier generated by the outreach module, such as via a URL. In a preferred embodiment, the URL may include a unique code that directs a user to a mobile responsive, encrypted response form.

Once the user is directed to the resource provided in relation to the unique identifier (e.g., URL), the system may be configured to present to the user verification questions (e.g., codes or user information) to confirm his/her identity. The system will use user responses and confirm such responses against information available to the system (e.g., stored in a storage medium, such as a database). Based on campaign settings, the system may terminate user access to a form or go to captcha mode after a number of bad entries.

In a preferred embodiment, the form provided by the system to the user's computing device will display with the colors, logos, campaign owner's domain name, and questions selected/created by the campaign owner during the campaign generation process (e.g., in conjunction with the outreach module). In certain cases, the form can also be pre-populated with user information to streamline the completion process.

In still further preferred embodiments, the system will provide users the ability or option to verify, update, provide, or invalidate information. This step can be across multiple pages/forms or one single page/form. In certain embodiments, a form may require particular data types and validation checks during the completion or submission process. The results can be displayed, downloaded, or synced to the campaign creator's database.

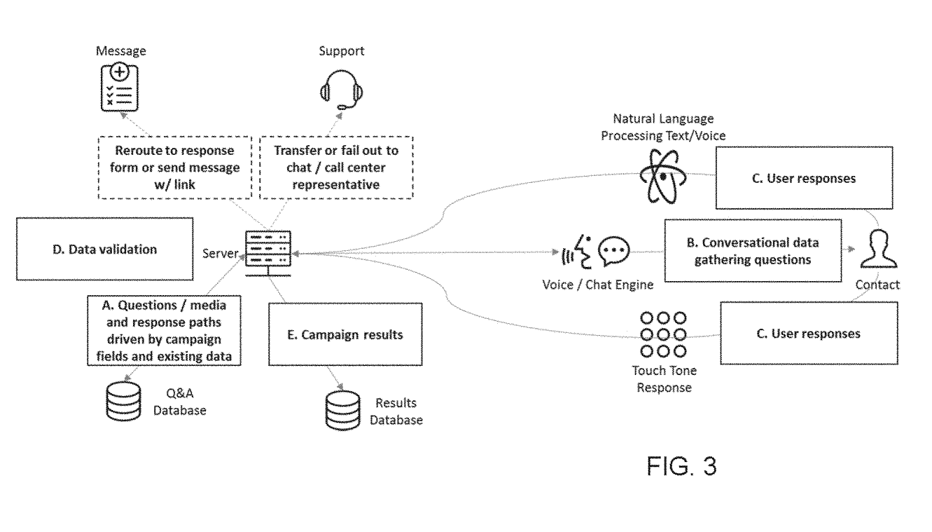

Turning now to FIG. 3, an alternative to response forms is shown. In particular, an interactive response, which will “conversationally” collect information from end users by chat/voice bot or touch-tone response, is shown. In this embodiment, creating a high quality interactive response campaign may require more upfront design than a response form. For instance, in preferred embodiments, the campaign creator will need to create media clips, chat scripts, and/or potentially action routing that is response dependent. Certain artificial intelligent means and training models can be leveraged to simplify and streamline the process, particularly where repeat or similar campaigns are being developed.

In certain embodiments, the system may be configured to provide a conversation mode, wherein the system may dial a contact or start a chat conversation with a user, then work through a series of dialogue options with the user (e.g., “if this, then that” questions / action paths). In other embodiments, a user may initiate the conversation with the system, and proceed through similar dialogue options. The users will answer the questions one by one as questions are asked. Responses may be processed in a number of manners, for instance, responses may be received and processed in the form of touch-tone submissions, voice recognition systems, natural language processing systems, or any combination thereof. One of ordinary skill in the art would appreciate that there are numerous methods for processing responses, and embodiments of the present invention are contemplated for use with any type of response processing method. If the system fails to interpret the response, it can ask the user to repeat the information and/or fail out to a call/chat representative. In certain embodiments, the user may also be provided the option to skip individual responses that they do not want to answer, as an alternative to preventing the system from proceeding for non-response.

In preferred embodiments, responses must meet validation standards similar to form based submissions in order to be accepted. However, alternatively, non-validated responses may be ignored and the process may be allowed to continue, even though certain responses were not received. The results can be displayed, downloaded, or synced to the campaign creator's database. In certain embodiments, the campaign designer may elect to only collect minimal information and follow up with a message/response form to collect additional information.

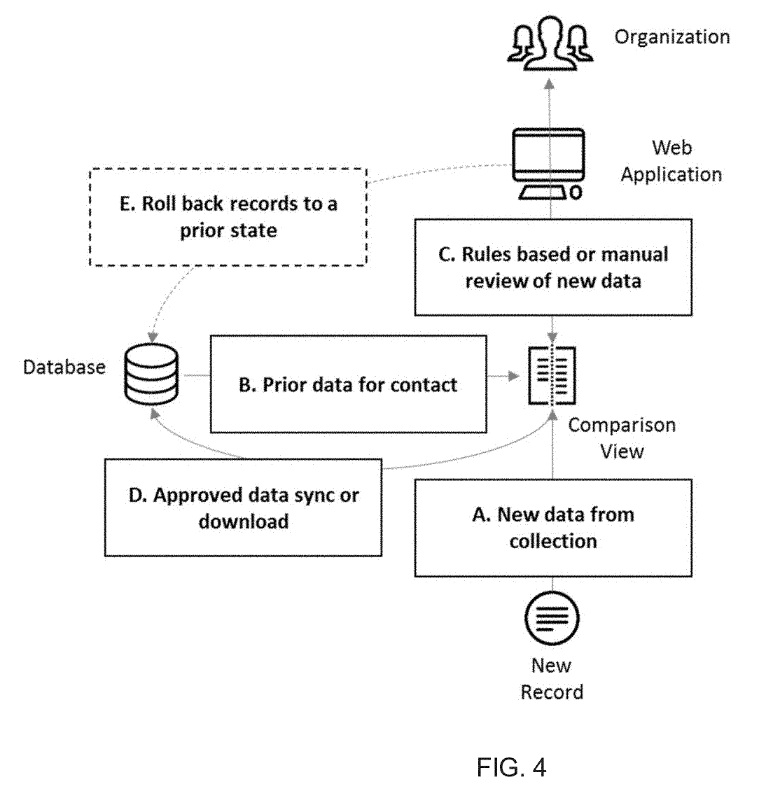

Turning now to FIG. 4, an overview of campaign response review is shown. In simple embodiments, a campaign owner may choose to send all results directly to a database or other data store. However, since the system is receiving user provided information, it may be necessary to review results. In preferred embodiments, the system will be configured with an automated rule set that is engaged to identify and flag results for review. Alternative embodiments may provide for manual review of some or all transactions.

In a preferred embodiment of the present invention, as new data is collected, the new data is entered into a results queue. Existing data is retrieved by the system (where applicable and available) and compared against new data. The system then runs the automated rule set against the compared data to approve or flag results for review. Review may be conducted automatically by the system or otherwise flagged for manual review. For example, all data that was verified by the end user and has not changed would require further review.

In a preferred embodiment of the present invention, approved data would be synced to the primary database or go into a results system for download. In still further embodiments, the system may be configured to provide versioning of data, whereby the system will save prior states of each data item so that the system admins can roll back individual records or entire campaigns. This can be particularly useful where there have been large scale issues (e.g., data corruption, data breaches).

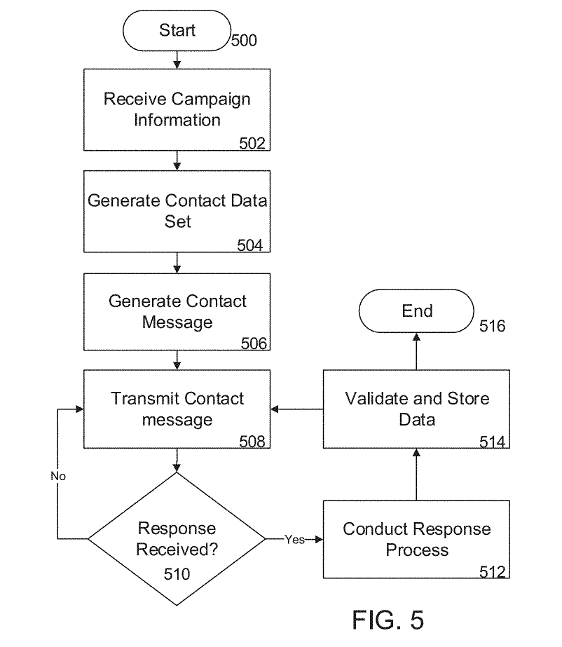

Turning now to FIG. 5, an exemplary embodiment of a method for providing secure crowdsourced updates of large datasets is shown. The process starts with the system being engaged at Step 500.

At step 502, the system receives campaign information. This may be by way of a user providing content required to generate a new campaign, or through retrieval of an existing campaign to be executed (or re-executed as the case may be). Campaign information may include, but is not limited to, a list of individuals to be contacted and their contact details (e.g., one or more means for communicating with the individuals), campaign response forms, campaign response form content, design elements (e.g., images, logos, color schemes, domains), contact rule sets and/or parameters, validation information, or any combination thereof.

At step 504, the system uses the received campaign information to generate a contact data set. The contact data set is a list or other structured or unstructured data set that comprises the contact information for one or more individuals. The system will utilize the contact data set to identify the individuals to be contacted through user or system created filters, as well as identification of the means the system will need to utilize in order to make such contacts. This may include selection of the appropriate modules the system will need in order to conduct the contacts (e.g., VOIP modules, API access modules, chat bot modules).

At step 506, the system generates the template contact message that will be used and sent to individuals on the contact data set. Each individual contact message generally will include one or more unique identifiers that allow for the user to respond to the contact message without the need for a password or other security means—however, certain embodiments may employ such security protocols, even when using unique identifiers.

Once generated, the system will transmit the contact message to the users (step 508). The system will determine which transmission means is appropriate, based at least in part on the data in the contact data set. For instance, if the contact information for a user is a phone number, the system may employ one or more voice dialers, PBX systems or modules, VOIP services or modules, or any combination thereof. One of ordinary skill in the art would appreciate that there are numerous modules the system could employ for these purposes.

Once the contact message is sent, the system then waits for a response. If no response is received, the system may repeat the contact by looping through step 508, or it may terminate the process if a timeout or other fault is thrown.

If a response is received, the system conducts the response process at step 512. Methods for conducting the response process are detailed previously herein, and the system may conduct response process in accordance with those methods. Once completed, the system will then validate and store the data at step 514. At this point, the process will terminate at step 516.

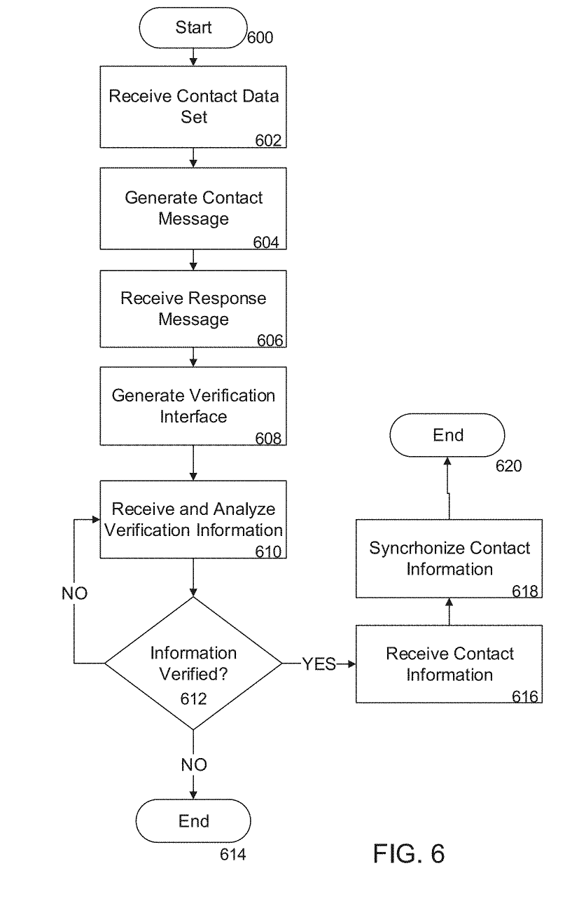

Turning now to FIG. 6 is an exemplary embodiment of a method for providing secure crowdsourced updates of large datasets. The process starts at step 600 with the system being engaged to provide the contact process. At step 602, the system receives or retrieves a contact data set. As detailed herein, the contact data set comprises the information required to contact individuals during the process.

As step 604, the system uses the individual information in the contact data set to generate a message comprising a unique identifier that the individual can use to engage with the system further to provide data to the system. Once generated, the system will transmit the generated message to the individual.

At step 606, the system receives a response message from the individual. For the present process, this may be, for instance, by way of a user clicking on a unique identifier in the generated message that was a unique URL that would send the user to a web page or form personalized based on that unique URL or unique code associated with the individual. This contact with the system in this case would be the response message. The response message may also take other formats, depending on the contact means associated with the individual (e.g., voice call, VOIP link, chat bot).

At step 608, since the individual has sent a response, the system then will identify the user via the provided unique identifier and generate a validation interface for the user to confirm their identity with the system. Again, the generation of the validation interface may leverage information stored in the contact data set to prepare validation questions or other means for validating the individual.

At step 610, the system receives the individual's response to the questions or other confirming data generated in the verification interface. The system will then analyze the responses for veracity. If the responses are not validated, then the system can either terminate the process (step 614) or loop the individual back through the validation process (step 610).

If the validation is accepted, the system then receives the contact information or other data provided by the individual for updating the data in the system (step 616). At step 618, the system will synchronize the contact information or other data of the individual with the existing data (optionally validating or analyzing the synchronized data). The process will then terminate at step 620.

Throughout this disclosure, numerous references are made to servers, services, interfaces, engines, modules, clients, peers, portals, platforms, or other systems formed from computing devices. It should be appreciated that the use of such terms is deemed to represent one or more computing devices having comprising one or more processors (e.g., ASIC, FPGA, DSP, x86, ARM, ColdFire, GPU, multi-core processors) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions.

One of ordinary skill in the art would further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, a circuit-switched network, the Internet, LAN, WAN, VPN, or other type of network. The terms “configured to” and “programmed to” in the context of a processor refer to being programmed by a set of software instructions to perform a function or set of functions.

While the inventive subject matter is susceptible of various modification and alternative embodiments, certain illustrated embodiments thereof are shown in the drawings and will be described below in detail. It should be understood, however, that there is no intention to limit the invention to the specific form disclosed, but on the contrary, the invention is to cover all modifications, alternative embodiments, and equivalents falling within the scope of the claims.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

In some embodiments, the numbers expressing quantities or ranges, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified, thus fulfilling the written description of all Markush groups used in the appended claims.

What is claimed is:

1. A computerized method for securely gathering information from a plurality of contacts, said computerized method using a multi-channel outreach module, a processor, a communications means, and one or more computerized messaging services, the method comprising the steps of:
receiving a first contact data set comprising one or more contact information entries;
generating a contact message for each of said one or more contact information entries,
wherein each contact message comprises a unique response identifier associated with one of said one or more contact information entries;
receiving a response message, wherein said response message is received in conjunction with usage of the unique response identifier;
generating a verification interface based on a contact information entry associated with said unique response identifier, wherein said verification interface comprises one or more verification challenge response tests;
providing said verification interface to a computing device identified in said response message;
receiving verification information, directly or indirectly, from said computing device identified in said response message;
validating verification information;
receiving information, directly or indirectly, from said computing device identified in said response message; and
synchronizing information for said contacts information entry associated with said unique response identifier.

2. The method of claim 1, further comprising the step of transmitting said contact message through a communication channel to a computing device associated with said one of said one or more contact information entries.

3. The method of claim 2, wherein said communication channel is selected from the group comprising: push notifications, SMS messages, email, social media platforms, mail, VOIP, voice calls, chat platforms, and advertisements.

4. The method of claim 1, further comprising the steps of:
receiving campaign information comprising selection of contact entries for use in said first contact data set;
generating a campaign based on said campaign information, wherein said campaign comprises one or more of content for said contact message, time to live information for said unique response identifier, and triggers for sending additional contact messages.

5. The method of claim 1, further comprising the steps of:
analyzing said one or more contact information entries of said first data set for entries that are restricted;
removing restricted entries from said one or more contact information entries from said first data set.

6. The method of claim 1, further comprising the steps of:
identifying a means of connection with said computing device identified in said response message; and
selecting a type of verification interface to be generated based on said means of connection with said computing device identified in said response message.

7. The method of claim 6, wherein said type of verification interface may be selected from the group comprising: user interfaces, messaging systems, call systems, encrypted response forms, unencrypted response forms, voice engines and chat engines.

8. The method of claim 1, further comprising the steps of:
comparing said contact information to information previously contained in said contact information entry associated with said unique response identifier; and
flagging said contact information for review based on one or more rules.

9. The method of claim 8, further comprising the step of disregarding said contact information wherein said contact information violates one or more of said one or more rules.

10. The method of claim 1, further comprising the step of saving version information for each contact information for said contact information entry associated with said unique response identifier in order to allow for later rollback of contact information.

11. A computerized system for securely gathering information from a plurality of contacts, said computerized system comprising:
a multi-channel outreach module, comprising computer-executable code stored in non-volatile memory;
a processor; and
one or more computer messaging devices;
wherein the multi-channel outreach module, the processor, and the one or more computer messaging devices are configured to:
receive a first contact data set comprising one or more contact information entries;
generate a contact message for each of said one or more contact information entries,
wherein each contact message comprises a unique response identifier associated with one of said one or more contact information entries;
receive a response message, wherein said response message is received in conjunction with usage of the unique response identifier;
generate a verification interface based on a contact information entry associated with said unique response identifier, wherein said verification interface comprises one or more verification challenge response tests;
provide said verification interface to a computing device identified in said response message;
receive verification information, directly or indirectly, from said computing device identified in said response message;
validate verification information;
receive contact information, directly or indirectly, from said computing device identified in said response message; and
synchronize contact information for said contacts information entry associated with said unique response identifier.

12. The system of claim 11, wherein the multi-channel outreach module, the processor, and the one or more computer messaging devices are further configured to: transmit said contact message through a communication channel to a computing device associated with said one of said one or more contact information entries.

13. The system of claim 12, wherein said communication channel is selected from the group comprising: push notifications, SMS messages, email, social media platforms, mail, VOIP, voice calls, chat platforms, and advertisements.

14. The system of claim 11, wherein the multi-channel outreach module, the processor, and the one or more computer messaging devices are further configured to:
receive campaign information comprising selection of contact entries for use in said first contact data set;
generate a campaign based on said campaign information, wherein said campaign comprises one or more of content for said contact message, time to live information for said unique response identifier, and triggers for sending additional contact messages.

15. The system of claim 11, wherein the multi-channel outreach module, the processor, and the one or more computer messaging devices are further configured to:
analyze said one or more contact information entries of said first data set for entries that are restricted;
remove restricted entries from said one or more contact information entries from said first data set.

16. The system of claim 11, wherein the multi-channel outreach module, the processor, and the one or more computer messaging devices are further configured to:
identify a means of connection with said computing device identified in said response message; and
select a type of verification interface to be generated based on said means of connection with said computing device identified in said response message.

17. The system of claim 16, wherein said type of verification interface may be selected from the group comprising: user interfaces, messaging systems, call systems, encrypted response forms, unencrypted response forms, voice engines and chat engines.

18. The system of claim 11, wherein the multi-channel outreach module, the processor, and the one or more computer messaging devices are further configured to:
compare said contact information to information previously contained in said contact information entry associated with said unique response identifier; and
flag said contact information for review based on one or more rules.

19. The system of claim 18, wherein the multi-channel outreach module, the processor, and the one or more computer messaging devices are further configured to disregard said contact information wherein said contact information violates one or more of said one or more rules.

20. The system of claim 11, wherein the multi-channel outreach module, the processor, and the one or more computer messaging devices are further configured to save version information for each contact information for said contact information entry associated with said unique response identifier in order to allow for later rollback of contact information.
